(19) United States
(12) Patent Application Publication
(10) Pub. No.: US 2022/0134899 A1
(43) Pub. Date: May 5, 2022

(54) DOCKING PORT AND BATTERY CHARGING DEPOT FOR AN UNMANNED AERIAL VEHICLE AND A METHOD FOR DOCKING AND CHARGING THE VEHICLE

(71) Applicant: WPC Wireless Power and Communication AS, Kristiansand (NO)

(72) Inventors: Helge Sverre Eide, Kleppe (NO); Geir Olav Gyland, Kristiansand (NO)

(73) Assignee: WPC Wireless Power and Communication AS, Kristiansand (NO)

(21) Appl. No.: 17/430,032

(22) PCT Filed: Feb. 11, 2020
(86) PCT No.: PCT/NO2020/050034

§ 371 Date: Aug. 11, 2021

(30) Foreign Application Priority Data
Feb. 11, 2019 (NO) 20190191

(51) Int. Cl. B60L 53/38; B64F 1/12; B64F 1/36; B64C 39/02; B64D 27/24; B64C 25/00; B60L 53/126; B60L 50/60; H02J 50/10; H02J 50/00; H02J 50/80; H02J 50/40; H02J 50/90

(52) U.S. Cl. CPC B60L 53/38; H02J 2310/44; B64F 1/362; B64C 39/024; B64D 27/24; B64C 25/001; B60L 53/126; B60L 50/60; H02J 50/10; H02J 50/005; H02J 50/80; H02J 50/402; H02J 50/90; B60L 2200/10; B64F 1/12

(57) ABSTRACT

A docking port is for an unmanned aerial vehicle being a rotorcraft, said docking port having at least one primary coil. The docking port has a primary coil housing formed with a funnel shaped indentation adapted to receive a complementary frustoconical shaped external surface of a secondary coil housing positioned on a landing gear of the rotorcraft, and the primary coil is formed to follow closely a funnel shaped indentation surface. The rotorcraft is charged wirelessly by the primary coil in the primary coil housing and a secondary coil in the secondary coil housing. The invention further concerns the landing gear and a system comprising the docking port and the landing gear. A method for docking the unmanned aerial vehicle on the docking port by use of a magnetic homing field is described.

### CROSS-REFERENCE TO RELATED APPLICATIONS

This application is the U.S. national stage application of International Application PCT/NO2020/050034, filed Feb. 11, 2020, which international application was published on Aug. 20, 2020, as International Publication WO 2020/167136 in the English language. The International Application claims priority of Norwegian Patent Application No. 20190191, filed Feb. 11, 2019. The international application and Norwegian application are both incorporated herein by reference, in entirety.

### FIELD

This invention concerns a docking port for an unmanned aerial vehicle (UAV). In addition, the docking port serves as a battery charging depot for the UAV. More particularly the UAV is a rotorcraft supplied with a battery package and electrical motors for propulsion. This invention concerns more particularly to charge the rotorcraft's battery package by inductive charging. In particular, the rotorcraft is provided with a landing gear, and the landing gear comprises at a free end portion a secondary coil housing for the receiving coil. Even more particularly the battery charging depot comprises a primary coil housing with an indentation, and the rotorcraft comprises a secondary coil housing that is formed frustoconical or conical. The indentation is complementary to the secondary coil housing. The invention concerns further a method for docking the rotorcraft on the docking port, where the final and accurate docking navigation is assisted by a magnetic homing field that is emitted by an electrical coil at the docking port. The electrical coil may be a primary coil used for inductive charging. The docking port is designed for docking of UAVs of different sizes and for UAVs provided with battery packages of different capacities.

### BACKGROUND

An unmanned aerial vehicle (UAV) is a fixed-wing aircraft or a multirotor helicopter. Multirotor helicopters may be a quadrotor helicopter which is also termed quadcopter or quadrotor. Multirotor helicopters may have more than four rotors. The term rotorcraft will be used as a generic term for a UAV of the helicopter type.

Rotorcrafts may be remotely controlled from a ground control. Rotorcrafts may also be autonomous. Autonomous rotorcrafts may be useful for surveillance missions and inspections of physical installations that are difficult to access. One example is a power line through remote and rugged terrain such as forests and mountains.

Many rotorcrafts are powered by a rechargeable battery package. Operation time is limited by the capacity of the battery package, and the weight of the battery package cannot exceed the payload weight. A fully autonomous rotorcraft should therefore be able to autonomously locate and land properly on a docking port which comprises a battery charging depot, recharge the battery package, transfer collected data from the mission, and continue the mission thereafter.

The docking port may also be positioned in remote and rugged terrain such as forests and mountains. The docking port should provide means for holding the rotorcraft immediately after landing to avoid that the rotorcraft is blown off by strong winds. The docking port should optionally provide shelter to the rotorcraft to protect the rotorcraft from bad weather.

The docking port and the battery charging depot should be able to identify the rotorcraft. It will be advantageous if the docking port and the battery charging depot are versatile such that rotorcrafts of different sizes can land on the docking port and be charged.

Rotorcrafts may perform aerial navigation by use of a GPS navigation system. The accuracy of GPS navigation is approximately 50 cm to a meter which is sufficient for surveillance and inspection missions, but too unprecise for the final part of an aerial docking operation. Visual aids such as use of ArUco or ChArUco boards may improve the accuracy. ArUco or ChArUco boards may be positioned on the docking station. However, visual aids are dependent on light and docking at night requires artificial light. In addition, snow and ice may cover the ArUco or ChArUco boards and make them useless. The part of the flight that is dedicated to navigation towards a docking station and including the landing phase, is termed homing.

It will be an advantage if the battery charging depot operates by wireless transfer of electrical energy. Such a charging system is more robust against water, snow and ice. However, snow and ice may increase the distance between the primary coil of the battery charging depot and the secondary coil which receives the electrical energy and is hardwired to the rechargeable battery. Snow and ice may make the wireless charging unit less efficient.

### SUMMARY

The invention has for its object to remedy or to reduce at least one of the drawbacks of the prior art, or at least provide a useful alternative to prior art.

The object is achieved through features, which are specified in the description below and in the claims that follow.

The invention concerns in one embodiment the use of one or several first electrical coils positioned on a docking port. This or these first electrical coils emit a magnetic field when electrical current flows in the electrical coils. The invention further concerns a rotorcraft that is provided with means for recognizing and/or measuring characteristics of the emitted magnetic field. The means may be a at least one second electrical coil or a plurality of second electrical coils.

The first and second electrical coil may be a primary coil and a secondary coil, respectively, in a wireless connector for transferring electrical energy from a battery charging depot at the docking port to the rotorcraft.

The magnetic field may further be optimised for homing by applying dedicated electrical pulses or even short DC power to amplify the magnetic field. The magnetic field can be modulated or altered so that identification information is transmitted to the rotorcraft to verify correct position and correct docking port.

The second electrical coil may be the secondary coil in the wireless connector. The secondary electrical coil may be used to receive and interpret the magnetic signal and magnetic field when the rotorcraft moves within the magnetic field.

In addition, the docking port and the rotorcraft comprise electronics which may be used as a guiding and homing system in the range of 0 to 1 m from the primary electrical coil.

When the rotorcraft is approaching the docking port, an onboard navigation system detects the docking port and enables to manoeuvre the rotorcraft to within approximately 50 cm accuracy of the docking port.

The primary coil or primary coils of the docking port is activated in homing mode and the rotorcraft detects the emitted magnetic field.

When the rotorcraft approaches the emitted magnetic field, identification information can be received and correct docking port and battery charging depot are verified. The rotorcraft enters into homing mode and will use the emitted magnetic field to precisely dock onto the inductive connectors of the wireless connector. Identification information and verification information can be exchanged between the docking port and the rotorcraft by other means such as radiocommunication.

One of the benefits of the wireless interface or connector is that it can fully support direct charging of most common battery technologies. Instead of adding a dedicated charger on the secondary side (receiver side) the wireless interface can handle the charging directly. This reduces cost and gives higher efficiency than adding a dedicated charger. Through the wireless interface, charging status, control and monitoring can be fully supported to the primary side (sender side).

This is achieved as the wireless interface is highly regulated and monitored. The variable power levels needed throughout the charging process can be directly adjusted by the wireless induction interface. Thus, the need for a second regulation step found in dedicated charging modules is eliminated.

Typical Battery Management System functionality can be provided as well with status reporting to external systems. Key benefits are reduced material cost and higher power efficiency as no second step dedicated charging regulation is required.

The invention is defined by the independent patent claims. The dependent claims define advantageous embodiments of the invention.

In a first aspect the invention relates more particularly to a docking port for an unmanned aerial vehicle. The unmanned aerial vehicle being a rotorcraft. The docking port comprises at least one primary coil. The docking port comprises a primary coil housing formed with a funnel shaped indentation adapted to receive a complementary frustoconical shaped external surface of a secondary coil housing positioned on a landing gear of the rotorcraft, and the primary coil is formed to follow closely a funnel shaped indentation surface.

The docking port may comprise a locking device for releasable fixation of the unmanned aerial vehicle (UAV) to the docking port. This embodiment has the advantage that the UAV is secured in the docking position and may not be blown off the docking port by strong winds.

The primary coil housing may comprise a through hole. This embodiment has the advantage that water is drained from the indentation. The through hole has in addition the advantage that a portion of the UAVs landing gear may protrude from an underside of the primary coil housing and facilitate fixation of the UAV to the docking port.

The primary coil housing may comprise radial grooves on the funnel shaped indentation surface. The indentation surface may engage an external surface of the secondary coil housing. This embodiment has the advantage that the secondary coil housing does not stick to the primary coil housing by differential pressure.

The primary coil housing may comprise a heating means. The heating means may be the primary coil. Snow and ice may accumulate in the indentation of the primary coil housing and even fill the indentation completely. Such snow and ice should be removed before docking of the UAV. These embodiments have the advantage that snow and ice will melt away prior to docking of the UAV.

The primary coil housing may comprise a plurality of primary coils, said plurality of primary coils are stacked on top of each other, and each primary coil is formed to follow closely the funnel shaped indentation surface. This embodiment has the advantage that the primary coil housing may receive secondary coil housings of different sizes. In addition, the charging effect may be regulated by the number of active primary coils. Another advantage is that the surface available for charging of relatively large secondary coil housings is larger compared to relatively small secondary coil housings. A light UAV will carry a relatively small rechargeable battery package compared to a heavier UAV, and the respective secondary coil housing is adapted to the charging capacity need.

The primary coil housing may comprise at least one primary communication coil, said primary communication coil may be adapted for forming a duplex inductive communication channel with a secondary communication coil.

The docking port may comprise at least two primary coil housings. This embodiment has the advantage that the charging capacity is increased. In one embodiment the docking port may comprise three primary coil housings. This embodiment has the advantage of creating a stable foundation for a tripod shaped landing gear. All three corresponding secondary coil housings may not house an active secondary coil. One or two of the corresponding secondary coil housings may act as support only. In one embodiment the docking port may comprise four primary coil housings. All four corresponding secondary coil housings may not house an active secondary coil. One to three of the corresponding secondary coil housings may act as support only. In one embodiment the docking port may comprise more than four primary coil housings. All corresponding secondary coil housings may not house an active secondary coil. Several of the corresponding secondary coil housings may act as support only.

The docking port may comprise means for adjusting a centre distance of the primary coil housings. This embodiment has the advantage that the docking port may receive UAVs of different sizes, and in particular UAVs with different sized landing gears. A light UAV will carry a landing gear with a relatively small footprint compared to a heavier UAV which will carry a landing gear with a relatively larger footprint.

The docking port may comprise a dedicated electrical coil for emitting a magnetic homing field. This embodiment has the advantage that the dedicated electrical coil may be positioned within a primary coil housing or elsewhere on the docking port. The magnetic field may further be optimised for homing by applying dedicated electrical pulses or even short DC power to amplify the magnetic field. The magnetic field can be modulated or altered so that identification information is transmitted to the UAV to verify correct position and correct battery charging depot.

In another embodiment one or several of the primary coils emit a magnetic homing field.

In a second aspect the invention relates more particularly to a landing gear for an unmanned aerial vehicle being. The unmanned aerial vehicle being a rotorcraft. The rotorcraft comprises a rechargeable electrical battery package. The landing gear comprises means for transfer of electrical energy from an electrical energy source to the rechargeable battery. The landing gear comprises at least one leg, and said leg comprises at a free end portion a conical or frustoconical secondary coil housing comprising a secondary coil adapted to receive electrical energy from a primary coil positioned in a primary coil housing positioned on a docking port, said primary coil housing is formed with a complementary funnel shaped indentation, and the secondary coil is formed to follow closely a conical or frustoconical external surface of the secondary coil housing.

The secondary coil housing may comprise at least one secondary communication coil, said secondary communication coil may be adapted for forming a duplex inductive communication channel with a primary communication coil.

The leg may comprise a locking means for releasable fixation of the unmanned aerial vehicle to the docking port. The locking means may comprise a nose at the free end portion of the leg. This embodiment has the advantage that the UAV is secured in the docking position and may not be blown off the docking port by strong winds. The nose forms an easily accessible structure for a locking device to engage with.

An external surface of the secondary coil housing may comprise radial grooves. This embodiment has the advantage that the secondary coil housing does not stick to the primary coil housing by differential pressure.

In a third aspect the invention relates more particularly to a system comprising an unmanned aerial vehicle being a rotorcraft and a docking port for the rotorcraft. The docking port is arranged for wireless transfer of electrical energy to the rotorcraft, when the rotorcraft is docked, by an inductive connector system comprising a primary coil. The rotorcraft is provided with means for aerial navigation. The system is provided with at least one first electrical coil arranged for emitting a magnetic homing field, and the rotorcraft is provided with at least one receiving means for measuring a strength of the emitted magnetic homing field) received by the receiving means, and the rotorcraft is provided with a positioning electronics that guides the rotorcraft in a horizontal plane (X-Y plane) to maximize the measured local magnetic homing field, said positioning electronics guides the rotorcraft in a vertical direction (Z-direction) when the measured magnetic homing field is at the local maximum and the magnetic homing field increases in strength when the rotorcraft descends towards the first coil.

The at least one first electrical coil may be the primary coil in the wireless connection for transfer of the electrical energy. This embodiment has the advantage that the primary coil is used for dual purpose which saves space and hard wiring.

The docking port may be provided with means for modulation or alteration of the magnetic homing field. The means for modulation or alteration of the magnetic homing field may be adapted for transferring information by the modulated or alternated magnetic homing field. This embodiment has the advantage that the magnetic homing field may serve as a backup for near range radiocommunication thus creating redundancy in the communication between the UAV and the docking port.

The at least one receiving means may be a second electrical coil, and the rotorcraft is provided with means for interpretation of the magnetic homing field.

The second electrical coil may be a secondary coil in a wireless connection for transfer of the electrical energy. This embodiment has the advantage that the secondary coil is used for dual purpose which saves space and hard wiring.

The means for aerial navigation may be a GPS system.

The primary coil housing may comprise at least one primary communication coil, and the secondary coil housing may comprise at least one secondary communication coil, said primary communication coil and secondary communication coil may be adapted for forming a duplex inductive communication channel between them.

This has the advantage that the wireless inductive connector may use an advanced internal regulation algorithm to control the output voltage and output current from the secondary coil. Said output voltage and output current is termed the secondary output at the secondary side. The regulation is based on feedback from the secondary side to the primary coil, making the primary coil to increase or decrease the amount of energy transmitted over the inductive gap between the primary coil housing and the secondary coil housing. When the wireless inductive connector is used as a standard power supply, the purpose of the regulation algorithm is to maintain the desired fixed voltage at the secondary output, and at the same time control the maximum current limit. With this technology the set points, that is the fixed voltage output and maximum current at the secondary side, may be adjusted by the secondary side with this technology. The charging algorithm for the battery will control the regulation feedback from the secondary side to the primary side, and this will adjust the output voltage and current to the battery from the secondary side. The charging algorithm will be a part of the regulation software on the secondary side. This regulation control will result in a change in the magnetic field emitted from the primary side which will change the output voltage and current to the battery. The wireless control communication between the primary side and the secondary side may be provided with the primary communication coil and the secondary communication coil forming the inductive communication channel. The wireless inductive communication channel is communicating at a high speed full duplex communication. The high-speed communication rate may be 200 kB/sec. The high-speed communication rate may be greater than 200 kB/sec for sending the control signal. This enable the system to control changes in voltage and current that is needed to charge the battery in different charging sequences.

Adjustments can be done as often as desired or required by the secondary side. At any time, any deviations from the set points and the measured voltage and current at the secondary output define the feedback values sent from the secondary side to the primary side. The full duplex wireless inductive communication channel also handles alarms, configurations and diagnostic that are needed for battery charging and safe regulation.

The possibility to adjust the set points through this high-speed wireless inductive communication channel makes it possible for the internal regulation algorithm to work as a battery charger. Thereby a separate battery charger is no longer needed. The secondary side will adjust its set points for output voltage and maximum current according to the battery voltage, the battery status and the battery charging parameters. The internal regulation algorithm is thereby a combined control system for dynamic energy transfer and battery charger.

There are several major benefits of combining the battery charging control and inductive regulation in one integrated system. There are fewer components at the secondary side and thereby weight is saved in the rotorcraft. There is less energy loss at the secondary side, which means that there is less rise of temperature and thereby a reduced need for cooling and cooling components. The total energy efficiency becomes better. In particular, an inductive communication channel offers a safe communication channel that is not disturbed by electromagnetic noise such as with a radiocommunication, or by objects such as with an optical based communication.

It is also described a method for docking an unmanned aerial vehicle being a rotorcraft on a docking port. The rotorcraft may be provided with a system for aerial navigation. The rotorcraft may be navigated to a first position at a first distance from the docking port by use of the system for aerial navigation. At least one first coil on the docking port emits a magnetic homing field which the rotorcraft recognizes by at least one receiving means. The receiving means measures the magnetic homing field. The rotorcraft enters a homing mode, and the rotorcraft is provided with a positioning electronics that guides the rotorcraft in a horizontal plane (X-Y plane) to maximize the measured local magnetic homing field, said positioning electronics guides the rotorcraft in a vertical direction (Z-direction) when the measured magnetic homing field is at the local maximum and the magnetic homing field increases in strength when the rotorcraft descends towards the first coil. The rotorcraft descends in the vertical direction (Z-direction) until the rotorcraft is correctly docketed onto the docking port.

The docking port may be provided with means for modulation or alteration of the magnetic homing field. The means for modulation or alteration of the magnetic homing field may be adapted for transferring information by the modulated or alternated magnetic homing field and the receiving means uses the information for calculation.

The at least one first electrical coil may be a primary coil in a wireless connection for transfer of electrical energy.

The at least one receiving means may comprise a second electrical coil. The second electrical coil may be a secondary coil in a wireless connection for transfer of electrical energy.

The system for aerial navigation may be a GPS system.

Each primary coil housing may comprise a collar. The collar may be shaped such that a collar rim abuts a corresponding collar rim of a neighbouring collar when the primary coil housings are displaced towards a centre of the docking port. In this position the collars form a tray. The primary coil housings are displaced towards the centre of the docking port when a comparable small or light rotorcraft approaches for docking. The tray forms an enlarged landing space such that the landing gear does not by mistake become stuck in a space between the primary coil housings.

The docking port may be supplied with electrical energy from a power grid, from a local windmill, from a local solar panel, or from a local battery bank. The docking port may be supplied with electrical energy from a combination of such electrical energy sources.

The rotorcraft may transfer collected data from a mission to a receiving device on the docking port. Transfer may be done by radiocommunication as known in the art. In one embodiment the primary coil housing comprises an integrated antenna and the secondary housing comprises an integrated antenna. Collected data is sent from the rotorcraft to the docking port through the antennas of the secondary coil housing and the primary coil housing during docking and charging of the rotorcraft. The rotorcraft may receive instructions for the next mission, as well as software updates, through the same communication system.

### BRIEF DESCRIPTION OF THE DRAWINGS

In the following is described examples of preferred embodiments illustrated in the accompanying drawings, wherein:

FIG. 1 shows schematically in perspective a rotorcraft provided with a landing gear according to the invention above a docking port according to the invention;

FIG. 2 shows the same as FIG. 1 and in addition a magnetic homing field for navigation onto the docking port;

FIG. 3 shows in the same scale as FIG. 1 the rotorcraft after completion of the landing;

FIG. 4 shows the same as FIG. 3 in a different embodiment;

FIG. 5 shows in the same scale as FIG. 1, a locking device for releasable fixation of the rotorcraft to the docking port, the docking port is seen from beneath;

FIG. 6 shows schematically in a larger scale a cross section through a free end portion of a foot of the landing gear with a secondary coil and a corresponding house of the docking port with a primary coil;

FIG. 7 shows the same as FIG. 6 in another embodiment with two stacked secondary coils at the free end portion of the foot of the landing gear, and with two stacked primary coils in the corresponding house of the docking port;

FIG. 8 shows the same as FIG. 6 in another embodiment where an a primary communication coil and a secondary communication coil are positioned in the house of the docking port and in the foot of the landing gear, respectively;

FIG. 9 shows the same as FIG. 7 in another embodiment where two primary communication coils and a secondary communication coil, are positioned in the house of the docking port and in the foot of the landing gear;

FIG. 10 shows schematically a prior art set up for inductive charging of a battery via a separate charger that comprises a battery regulation and charging; and

FIG. 11 shows schematically a set up for inductive charging of a battery with a high speed full duplex inductive communication channel between the primary communication coil and the secondary communication coil.

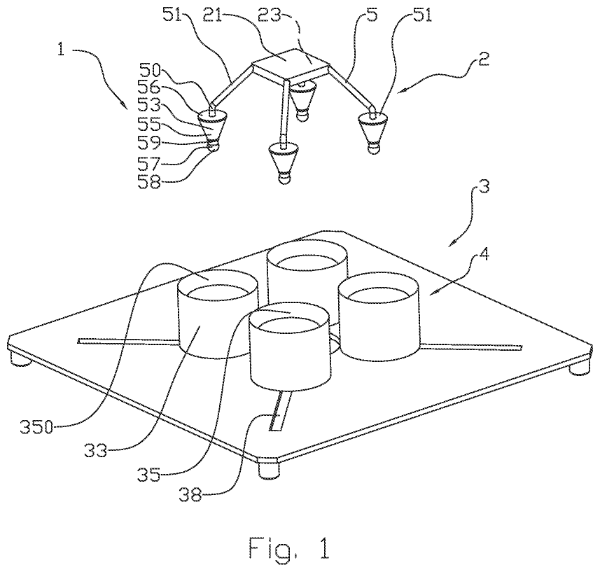

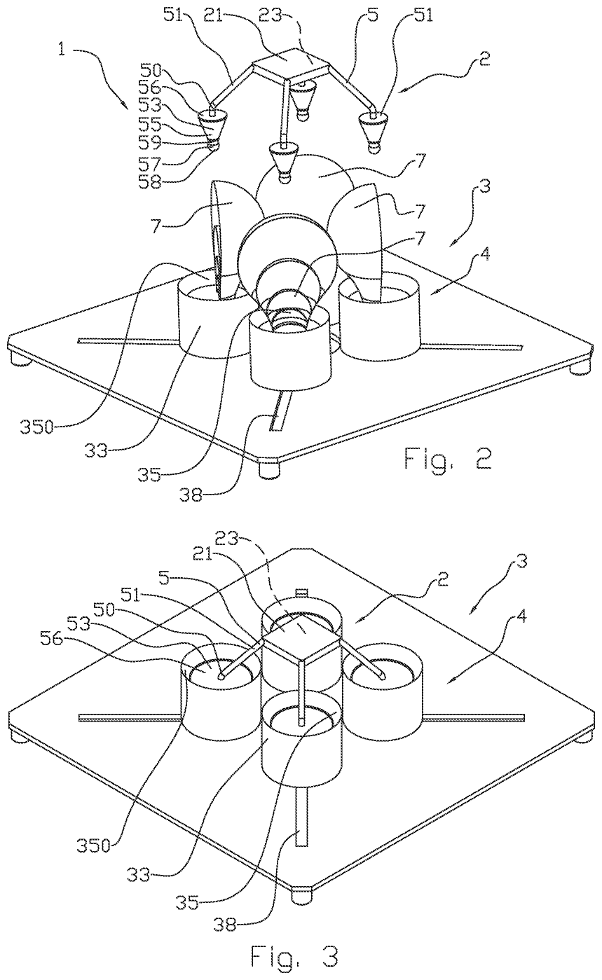

### DETAILED DESCRIPTION OF THE DRAWINGS

In the drawings, the reference numeral 1 indicates a system. The system 1 comprises an unmanned aerial vehicle (UAV) 2 and a docking port 3. The UAV 2 is schematically shown in the drawings as a rotorcraft 21. The rotor/rotor blades of the rotorcraft 21 have been omitted in the drawings. The rotorcraft 21 comprises rechargeable batteries 23. The docking port 3 is provided with a battery charging depot 4. The battery charging depot 4 is arranged for transfer of electrical energy to the rotorcraft 21 when the rotorcraft 21 is docked.

The rotorcraft 21 comprises a landing gear 5. The landing gear 5 comprises means 51 for transfer of electrical energy from an electrical energy source (not shown) at the docking port 3 to the rechargeable battery 23.

In the figures, the landing gear 5 is shown as a landing gear comprising four legs 51, however the invention is not limited to this configuration. In one embodiment (not shown) the landing gear 5 may comprise only one leg 51 or pole 51. The one leg 51 or pole 51 is sufficiently robust to carry the weight of the rotorcraft 21 and to withstand lateral forces from wind when the rotorcraft 21 is docked. In an alternative embodiment the landing gear 5 may comprise two legs 51. In an alternative embodiment the landing gear 5 may comprise three legs 51, said landing gear 5 forming a tripod. A landing gear 5 comprising one, two or three legs 51 have the advantage that the landing gear 5 will not tip on a surface. The landing gear 5 may in a further embodiment comprise more than four legs 51.

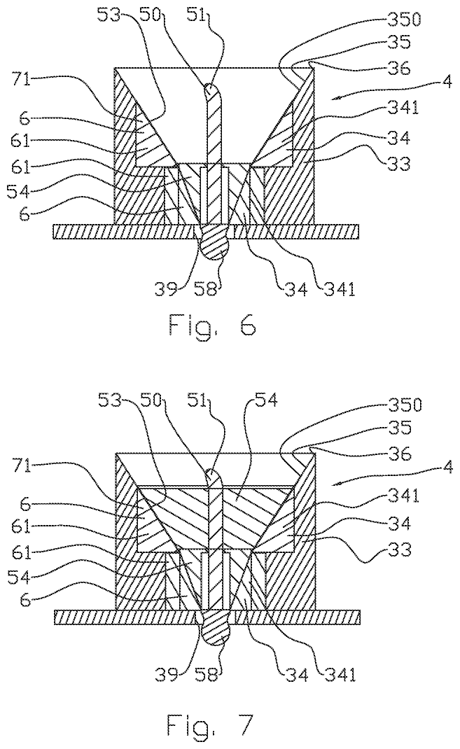

The leg 51 comprises at a free end portion 50 a secondary coil housing 53. A secondary electrical coil 54 is positioned inside the housing 53 (see FIGS. 6 and 7). The secondary coil housing 53 is shown as a housing 53 formed with a frustoconical shaped external surface 55. The housing 53 may in one embodiment (not shown) be formed with a conical shaped external surface 55. The secondary electrical coil 54 (see FIGS. 6 and 7) is formed frustoconical such that the secondary electrical coil 54 follows closely the external surface 55.

The landing gear 5 comprises a locking means 57. The locking means 57 may be a nose 58 that is positioned at the free end portion 50. The nose 58 may be positioned at a tip 59 of the free end portion 50.

The external surface 55 may comprise first radial grooves (not shown). The radial grooves are formed between the nose 58 and a base 56 of the conical or frustoconical formed external surface 55.

The docking port 3 comprises at least one primary coil housing 33. The primary coil housing 33 is provided with a funnel shaped indentation 35. The indentation 35 is complementary to the external surface 55 of the secondary coil housing 53.

The docking port 3 may comprise a locking device 37 (see FIG. 5) which is adapted to connect with the locking means 57. The locking device 37 fixes the rotorcraft 21 to the docking port 3. The locking device 37 may comprise a gripper 371 that interacts with the nose 58. In one embodiment, as shown, the gripper 371 comprises a slot formed with a wide end portion and a narrow end portion. The gripper 371 is displaceable such that when the rotorcraft 21 lands or takes off, the wide end portion encompasses the nose 58. After landing, the gripper is displaced such that the narrow end portion encompasses the nose 58 and thereby locks the nose 58.

The primary coil housing 33 comprises a through hole 39 (see FIGS. 6 and 7). The through hole 39 is wider than the nose 58 such that the nose 58 protrudes from the primary coil housing 33 when the secondary coil housing 53 rests in the primary coil housing 33.

The primary coil housing 33 may comprise second radial grooves (not shown) on an indentation surface 350. The radial grooves are formed between the through hole 39 and an edge 36 of the funnel shaped indentation 35.

The primary coil housing 33 comprises in one embodiment a single primary electrical coil 34. The primary electrical coil 34 is formed such that the primary electrical coil 34 follows closely the indentation surface 35. In an alternative embodiment the primary electrical coil 34 comprises a plurality of independent electrical coils 341 stacked side by side/on top of each other.

The docking port 3 may in one embodiment comprise at least two primary coil housings 33. The docking port 3 may comprise adjusting means 38 for regulating a centre distance between the primary coil housings 33. The adjusting means 38 may be operated by a motor, such as a step motor (not shown). The adjusting means 38 may comprise a gear (not shown). The adjusting means 38 may operate each primary coil housing 33 individually or in a coordinated manner. The adjusting means 38 may be protected from the surroundings by a suitable housing or by panels (not shown).

The primary coil housing 33 and the primary electrical coil 34 form the battery charging depot 4 for the rotorcraft 21. The battery charging depot 4 transfers electrical energy by induction to the rotorcraft's 21 rechargeable batteries 23 from the primary electrical coil 34 to the secondary electrical coil 54. The secondary electrical coil 54 is connected to the batteries 23 by wiring.

The primary coil housing 33 may comprise heating means 6. The heating means 6 may be an electrical heating element 61 adapted to melt snow and ice that may accumulate in the indentation 35. Water such as rainwater or melt water, is drained from the indentation 35 through the hole 39. The primary electrical coil 34, 341 may act as heating means 6.

In one embodiment the primary electrical coil 34 is adapted to be a first electrical coil 71 (see FIGS. 6 and 7) that emits a magnetic homing field 7 as schematically shown in FIG. 2.

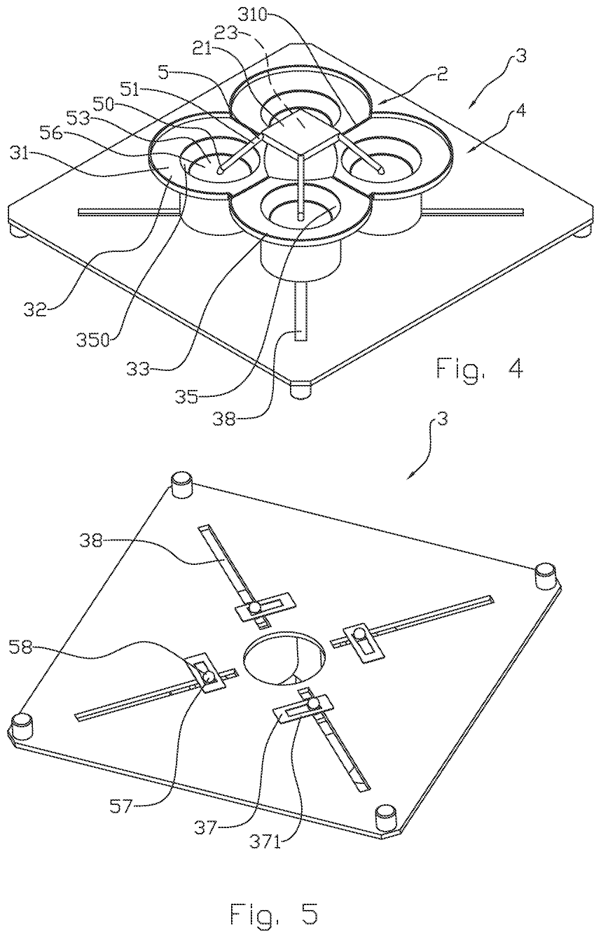

In one embodiment each primary coil housing 33 comprises a collar 31 as shown in FIG. 4. The collar 31 is shaped such that a collar rim 310 abuts a corresponding collar rim of 310 of a neighbouring collar 31 when the primary coil housings 33 are displaced towards a centre of the docking port 3. In this position the collars 31 form a tray 32. The primary coil housings 33 are displaced towards the centre of the docking port 3 when a comparable small or light rotorcraft 21 approaches for docking. The tray 32 forms an enlarged landing space such that the landing gear 5 does not by mistake become stuck in a space between the primary coil housings 33.

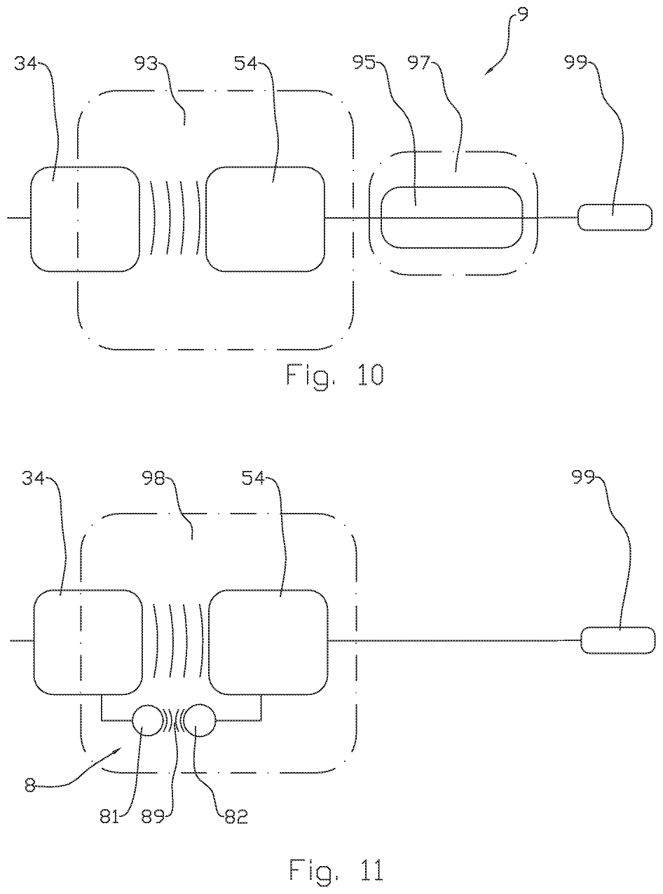

FIG. 10 shows a prior art charging set up 9 for charging a battery 91 with electrical power from a wireless power transmission. Electrical power is transferred from a primary coil 34 to a secondary coil 54. The wireless power transmission is controlled by a wireless regulation and monitoring means 93. Power is transferred to a battery charger 95. The battery charger 95 is controlled by a battery regulation and monitoring means 97. The battery charger 95 provides a battery 99 with electrical energy.

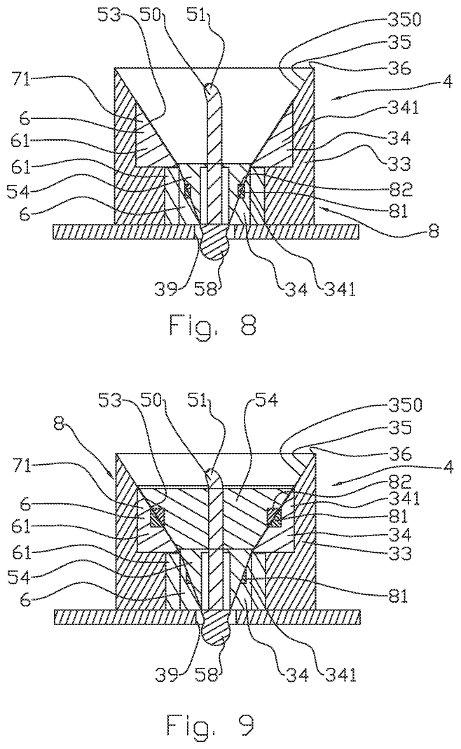

In one embodiment according to the invention, each primary coil housing 33 comprises at least one primary communication coil 81 forming an inductive communication channel 8. The primary communication coil 81 is adapted for inductive duplex communication 89 with a secondary communication coil 82 in the inductive communication channel 8, as seen in FIGS. 8, 9 and 11. The inductive duplex communication channel 8 may be a high-speed communication channel. The high-speed communication may be at a speed of 200 kB/sec or greater than 200 kB/sec. The inductive communication channel 8 is protected from disturbances from the surroundings as the primary communication coil 81 and the secondary communication coil 82 are protected within the primary coil housing 33 and the secondary coil housing 53, respectively. The battery regulation and monitoring means and the inductive power regulation and monitoring means are combined in one system 98.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1.-29. (canceled)

30. A docking port for an unmanned aerial vehicle being a rotorcraft, said docking port comprising at least one primary coil, the docking port comprises a primary coil housing formed with a funnel shaped indentation adapted to receive a complementary frustoconical shaped external surface of a secondary coil housing positioned on a landing gear of the rotorcraft, and the primary coil is formed to follow closely a funnel shaped indentation surface, wherein the primary coil housing comprises at least one primary communication coil, said primary communication coil is adapted for forming a duplex inductive communication channel with a secondary communication coil.

31. The docking port according to claim 30, wherein the docking port comprises a locking device for releasable fixation of the unmanned aerial vehicle to the docking port.

32. The docking port according to claim 30, wherein the primary coil housing comprises a through hole.

33. The docking port according to claim 30, wherein the primary coil housing comprises radial grooves on the funnel shaped indentation surface.

34. The docking port according to claim 30, wherein the primary coil housing comprises a plurality of primary coils, said plurality of primary coils are stacked on top of each other, and each primary coil is formed to follow closely the funnel shaped indentation surface.

35. The docking port according to claim 30, wherein the docking port comprises at least two primary coil housings.

36. The docking port according to claim 35, wherein the docking port comprises means for adjusting a center distance of the primary coil housings.

37. The docking port according to claim 30, wherein the docking port comprises a dedicated electrical coil for emitting a magnetic homing field.

38. A landing gear for an unmanned aerial vehicle being a rotorcraft, said rotorcraft comprising a rechargeable electrical battery package, said landing gear comprising means for transfer of electrical energy from an electrical energy source to the rechargeable battery, the landing gear comprises at least one leg, said leg comprises at a free end portion a conical or frustoconical secondary coil housing comprising a secondary coil adapted to receive electrical energy from a primary coil positioned in a primary coil housing positioned on a docking port, said primary coil housing is formed with a complementary funnel shaped indentation, and the secondary coil is formed to follow closely a conical or frustoconical external surface of the secondary coil housing, wherein the secondary coil housing comprises at least one secondary communication coil, said secondary communication coil is adapted for forming a duplex inductive communication channel with a primary communication coil.

39. The landing gear according to claim 38, wherein said leg comprises a locking means for releasable fixation of the unmanned aerial vehicle to the docking port, said locking means comprises a nose at the free end portion of the leg.

40. The landing gear according to claim 38, wherein an external surface of the secondary coil housing comprises radial grooves.

41. A system comprising an unmanned aerial vehicle being a rotorcraft and a docking port for the rotorcraft, where the docking port is arranged for transfer of electrical energy to the rotorcraft when the rotorcraft is docked, through a primary coil, and the rotorcraft is provided with means for aerial navigation, the docking port is provided with at least one first coil arranged for emitting a magnetic homing field, and the rotorcraft is provided with at least one receiving means for measuring a strength of the emitted magnetic homing field received by the receiving means, and the rotorcraft is provided with a positioning electronics that guides the rotorcraft in a horizontal plane (X-Y plane) to maximize the measured local magnetic homing field, said positioning electronics guides the rotorcraft in a vertical direction (Z-direction) when the measured magnetic homing field is at the local maximum and the magnetic homing field increases in strength when the rotorcraft descends towards the first coil, wherein primary coil housing comprises at least one primary communication coil, and the secondary coil housing comprises at least one secondary communication coil, said primary communication coil and secondary communication coil are adapted for forming a duplex inductive communication channel between them.

42. The system according to claim 41, wherein the at least one first electrical coil is a primary coil in a wireless connection for transfer of the electrical energy.

43. The system according to claim 41, wherein the docking port is provided with means for modulation or alteration of the magnetic homing field.

44. The system according to claim 43, wherein the means for modulation or alteration of the magnetic homing field is adapted for transferring information by the modulated or alternated magnetic homing field.

45. The system according to claim 41, wherein the at least one receiving means is a second electrical coil, and the rotorcraft is provided with means for interpretation of the magnetic homing field.

46. The system according to claim 45, wherein the second electrical coil is a secondary coil in a wireless connection for transfer of the electrical energy.
